(19) United States
(12) Patent Application Publication
(10) Pub. No.: US 2026/0104836 A1
(43) Pub. Date: Apr. 16, 2026

(54) VIDEO DISPLAY DEVICE, SYSTEM, AND CONTROL METHOD BASED ON MESSENGER PLATFORM LINKAGE

(71) Applicant: LG ELECTRONICS INC., Seoul (KR)

(72) Inventors: Hyojin KIM, Seoul (KR); Jinuk LEE, Seoul (KR); Changhyeon HONG, Seoul (KR); Minjae CHOI, Seoul (KR); Suyeong WON, Seoul (KR)

(73) Assignee: LG ELECTRONICS INC., Seoul (KR)

(21) Appl. No.: 19/359,092

(22) Filed: Oct. 15, 2025

(30) Foreign Application Priority Data
Oct. 15, 2024 (KR) 10-2024-0139941
Sep. 10, 2025 (WO) PCT/KR2025/014096

(51) Int. Cl. G06F 3/14; H04N 21/431; H04N 21/443; H04N 21/458; H04N 21/658

(52) U.S. Cl. CPC G06F 3/1454; H04N 21/4316; H04N 21/4432; H04N 21/458; H04N 21/658

(57) ABSTRACT

A video display device according to various embodiments of the present specification includes a communication device configured to transmit and receive data with an external server, a display configured to display content, and a processor configured to control the display to display the content, wherein the processor is configured to provide a power state of the video display device to the external server, and receive the content from the external server and display the content on the display at a time point determined based on the power state of the video display device and a scheduled transmission time of the content.

### CROSS REFERENCE TO RELATED APPLICATION

The present application claims priority to Korean Patent Application No. 10-2024-0139941, filed Oct. 15, 2024, and PCT Patent Application No. PCT/KR2025/014096, filed Sep. 10, 2015, the entire contents of which is incorporated herein for all purposes by these references.

### FIELD

The present specification relates to a video display device, system, and a control method thereof, which receive content transmitted from an external server via a messenger platform or a social network service (SNS) platform and display the content on the video display device.

### BACKGROUND

Photos, videos, and/or documents captured or downloaded via mobile devices are often shared with other users, and this sharing occurs via SNS platforms. However, this sharing can be difficult for those unfamiliar with the SNS platforms.

Meanwhile, video display devices such as a TV and a monitor are evolving from simple broadcast receivers into smart devices that provide various types of content in conjunction with the Internet. However, the video display devices are still limited to merely displaying content transmitted from a mobile terminal. In addition, in implementing the SNS platform on the video display device, it is difficult to indicate content reception when the device is turned off, and it is difficult for the user to immediately check the content even after turning on the device.

### SUMMARY

Accordingly, the present specification is directed to providing a video display device that implements SNS platform functions capable of resolving the above inconveniences and enhancing user convenience.

Objects of the present specification are not limited to the above objects, and other objects that are not described will be able to be clearly understood by those skilled in the art to which the present disclosure pertains based on the following description.

According to one embodiment of the present specification, there is provided a video display device including a communication device configured to transmit and receive data with an external server, a display configured to display content, and a processor configured to control the display to display the content, wherein the processor is configured to provide a power state of the video display device to the external server, and receive the content from the external server and display the content on the display at a time point determined based on the power state of the video display device and a scheduled transmission time of the content.

The processor may be configured to display information on the content received from the external server on a pop-up screen of the display, and display the content on the display when a display option is selected by a user.

The processor may be configured to turn on a screen of the display and change the power state of the video display device to an on state when beginning to receive the content from the external server while the power state of the video display device is in an off state with the display turned off.

The processor may be configured to receive scheduled content transmission information including a scheduled content transmission time, content location information, and one or more identification information from the external server.

The processor may be configured to turn on a screen of the display and change the power state of the video display device to an on state before the scheduled content transmission time when the power state of the video display device is in an off state with the display turned. and to wait for content reception from the server.

The processor may be configured to group a plurality of received contents according to identification information of a user transmitting the corresponding content and display the grouped content on the display.

The processor may be configured to classify a plurality of received contents according to content type or theme, and to group and display the classified content according to content type or theme.

The processor may be configured to periodically determine whether a storage period of content stored in the video display device or the external server has expired. and to provide a notification before the storage period expires.

The processor may be configured to upload content within the video display device to the server so as to be transmitted to an external electronic device linked to a specific account when a user selects the specific account.

According to another embodiment of the present specification, there is provided a method of displaying content of a video display device, which displays content requested by an external electronic device on a display in conjunction with an external server, including providing a power state of the video display device to the external server, receiving the content from the external server at a time point determined based on the power state of the video display device and a scheduled transmission time of the content, and displaying the received content on the display.

The displaying of the received content on the display may include displaying information on the content received from the external server on a pop-up screen of the display, and displaying the content on the display when a display option is selected by a user.

The displaying of the received content on the display may include turning on the display and changing the power state of the video display device to an on state when beginning to receive the content from the external server while the power state of the video display device is in an off state with the display turned off, and displaying the received content on the turned-on display.

The method may further include receiving scheduled content transmission information including a scheduled content transmission time, content location information, and one or more identification information from the external server.

The method may further include turning on a screen of the display and changing the power state of the video display device to an on state before the scheduled content transmission time when the power state of the video display device is in an off state with the display turned off, and waiting for content reception from the server.

The method may further include grouping a plurality of received contents according to identification information of a user transmitting the corresponding content and displaying the grouped content on the display.

The method may further include classifying a plurality of received contents according to content type or theme, and grouping and displaying the classified content according to content type or theme.

The method may further include periodically determining whether a storage period of content stored in the video display device or the external server has expired, and displaying a notification message on the display before the storage period expires.

The method may further include uploading content within the video display device to the server so as to be transmitted to an external electronic device linked to a specific account when a user selects the specific account.

According to still another embodiment of the present specification, there is provided a method of operating a content sharing server, including receiving a content transmission request in which a scheduled transmission time point to a video display device is set from an external electronic device, receiving a power state from the video display device, determining whether to transmit the content to the video display device based on a power state of the video display device and the scheduled transmission time point, and transmitting the content to the video display device based on the determination.

The determining of whether to transmit the content to the video display device may include determining transmission of the content at the scheduled time point regardless of the power state of the video display device, or determining transmission of the content when the power state of the video display device is in an on state with the display turned on after the scheduled time point.

Since the video display device is linked with the external server to autonomously receive and display content, smooth content sharing can be achieved without user intervention.

Through automatic control according to the power state and the scheduled time, the manual manipulation of the user can be minimized, thereby improving user convenience.

Effects obtainable from the present specification are not limited to the above-described effects, and other effects that are not described will be able to be clearly understood by those skilled in the art to which the present disclosure pertains based on the following description.

### BRIEF DESCRIPTION OF THE DRAWINGS

FIG. 1 is a block diagram illustrating a configuration of a video display device, an external server, and an external electronic device according to one embodiment.

FIG. 2 is a flowchart illustrating a method of displaying content on a video display device according to one embodiment.

FIG. 3 is an exemplary view illustrating a user interface for transmitting content from an external electronic device to the video display device.

FIG. 4 is an exemplary view illustrating a screen for providing a user with information on content received from an external electronic device on a display screen of the video display device according to one embodiment.

FIG. 5 is a flowchart illustrating a process of transmitting scheduled content from an external server according to one embodiment.

FIG. 6 is an exemplary view illustrating a screen for displaying content received from a plurality of users on the video display device according to one embodiment.

FIG. 7 is an exemplary view illustrating a screen for displaying content classification and classification menu display operations according to one embodiment.

FIG. 8 is an exemplary view illustrating a screen when there is no shared content according to one embodiment.

FIG. 9 is an exemplary view illustrating storage period management and expiration notification according to one embodiment.

FIG. 10 is a flowchart illustrating a process of receiving content by referencing location information of an external electronic device according to one embodiment of the present invention.

### DETAILED DESCRIPTION OF THE EMBODIMENT

Advantages and features of the present specification and methods for achieving them will become clear by referencing embodiments to be described below in detail in conjunction with the accompanying drawings. However, the present specification is not limited to the embodiments to be disclosed below but can be implemented in various different forms, these embodiments are merely provided to make the disclosure of the present specification complete and fully inform those skilled in the art to which the present specification pertains of the scope of the present specification, and the present specification is only defined by the scope of the appended claims. The same reference number denotes the same components throughout the specification.

When a first component is “connected to” or “coupled to” a second component, it includes both a case in which the first component is directly connected or coupled to the second component or a case in which other components are interposed therebetween. On the other hand, when one component is “directly connected to” or “directly coupled to” another component, it means that still another component is not interposed therebetween. The term “and/or” includes each of stated items and any combination of one or more.

Terms used in the present specification are intended to describe the embodiments and are not intended to limit the present disclosure. In the present specification, the singular form also includes the plural form unless specifically stated in the phrase. As used herein, “comprises” and/or “comprising” means that the stated component, step, operation, and/or element do not preclude the presence of addition of one or more other components, steps, operations, and/or elements.

Although first, second, and the like are used to describe various components, it goes without saying that these components are not limited by these terms. These terms are only used to distinguish one component from another component.

Accordingly, it is apparent that a first component to be described below may be a second component within the technical spirit of the present specification. Unless otherwise defined, all terms (including technical and scientific terms) used in the specification may be used as meaning commonly understood by those skilled in the art to which the present specification pertains. In addition, terms defined in commonly used dictionaries are not construed ideally or excessively unless clearly and specially defined.

The term “unit” or “module” used in the present embodiment is software or a hardware component such as a field programmable gate array (FPGA) or an application specific integrated circuit (ASIC), and the “unit” or “module” performs certain functions. However, the “unit” or “module” is not limited to software or hardware. The “unit” or “module” may be configured to be disposed in an addressable storage medium and configured to operate one or more processors. Therefore, as an example, the “unit” or “module” is components such as software components, object-oriented software components, class components, and task components, processes, functions, properties, procedures, subroutines, segments of program code, drivers, firmware, microcode, circuitry, data, databases, data structures, tables, arrays, and variables. Functions provided in components and “units” or “modules” may be combined into the smaller number of components and “unit” or “modules” or separated into additional components and “units” or “modules.”

Operations of a method or algorithm described in connection with some embodiments of the present specification may be implemented directly in hardware and software modules executed by a processor or a combination of the two. The software modules may reside in a RAM, a flash memory, a ROM, an EPROM, an EEPROM, a register, a hard disk, a removable disk, a CD-ROM, or any other form of recording medium known in the art. An exemplary recording medium is coupled to a processor, and the processor may read information from the recording medium and write the information to the storage medium. As another method, the recording medium may be integrated with the processor. The processor and the recording medium may reside in an ASIC. The ASIC may reside in a user terminal.

Hereinafter, various embodiments of the present specification will be described in detail with reference to the accompanying drawings so that those skilled in the art to which the present specification pertains can easily carry out the embodiments of the present specification. However, the present specification may be implemented in various different forms and is not limited to the embodiments described herein.

The present specification has been described with reference to various embodiments illustrated in the drawings, but these are merely illustrative, and those skilled in the art will understand that various modifications and other equivalent embodiments are possible therefrom. Accordingly, the true technical scope of the present specification should be determined by the technical spirit of the appended claims.

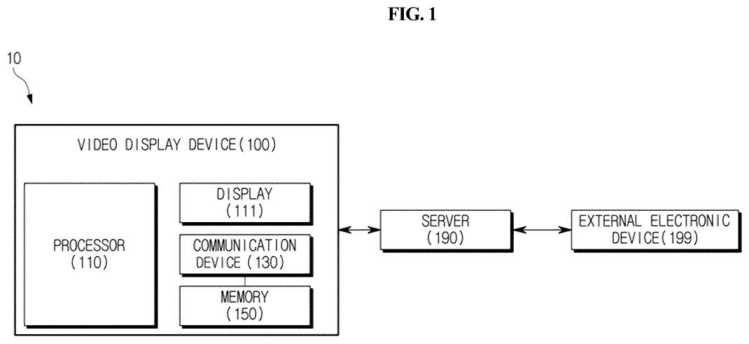

FIG. 1 is a block diagram illustrating a configuration of a video display device, an external server, and an external electronic device according to one embodiment.

Referring to FIG. 1, a video display system 10 according to one embodiment may include a video display device 100, an external server 190, and an external electronic device 199. The video display device 100 may include a processor 110, a display 111, a communication device 130, and a memory 150. The video display device 100 may be linked with the external server 190 and the external electronic device 199. Based on such a basic configuration, the video display device 100 may provide a broadcast reception function, an Internet-based content playback function, and/or a linkage function with an external electronic device and may be implemented in the form of a smart TV, a monitor, and/or a set-top box.

According to one embodiment, the processor 110 is a central control device that comprehensively controls the operation of the video display device 100 and may generally be implemented in the form of a system-on-chip (SoC) that includes a central processing unit (CPU), a graphics processing unit (GPU), a neural processing unit (NPU), a memory controller, and/or an input/output controller.

According to one embodiment, the processor 110 may process signals received from the outside to convert the signals into video signals suitable for the display 111 and exchange control signals with each component including the communication device 130 and the memory 150 within the video display device 100 to ensure the normal operation of the device.

The processor 110 may receive commands from a user input device (not illustrated), interpret the commands, and reflect the interpreted commands in the operation of the video display device 100.

The processor 110 may decode broadcast signals, signals received from the external electronic device 199, and data received via the external server 190 and display the signals and the data on the display 111. The processor 110 may control a resolution, a screen ratio, and/or brightness while displaying the processed video data on the display 111.

The processor 110 may store and manage content, user settings, and/or log data in conjunction with the memory 150.

The processor 110 may control data transmission and reception with the external server 190 via the communication device 130. The processor 110 may perform security/authentication functions, content encryption, access control, and authentication procedures.

According to one embodiment, the processor 110 may detect a power state of the video display device 100 and transmit the detected information to the external server 190. In addition, the processor 110 may receive and manage a scheduled content transmission time, content location information, and/or identification information from the external server 190. According to one embodiment, when the video display device 100 is in a state of being turned off at the scheduled content transmission time, the processor 110 may turn on the video display device 100 at the scheduled content transmission time.

The processor 110 may classify content provided by a plurality of users by user and control the display 111 to display user information together with each content. In addition, the processor 110 may classify content by type (photo, video, document, and/or link) or content and control menus on a user interface (UI) based on the result of classification. Furthermore, the processor 110 may manage a content storage period, provide a notification prior to expiration, and extend the storage period according to the user's selection. When the storage period expires, the processor can rereceive the content by referencing location information provided by the external electronic device 199.

The processor 110 may manage a state of shared content in a chat space of the external server 190 and display the content to the user. When a plurality of content are received, control may be performed such that the user selectively downloads only specific content, and only representative information for the non-selected content may be maintained in a visualized form.

When the user selects a specific account, the processor 110 may transmit the content stored in the video display device 100 to the external electronic device 199 linked to the corresponding account. According to one embodiment, when the user selects the specific account, the processor 110 may upload the content stored in the video display device 100 to the external server 190 so as to be transmitted to the external electronic device 199 linked to the account.

According to one embodiment, the display 111 is a screen output device of the video display device 100 and may display content provided from the external server 190 or the external electronic device 199 under the control of the processor 110.

The display 111 may display various types of information, such as still images, videos, text, graphics, and/or graphical user interfaces (GUIs), and include or be linked to the following components. The display 111 may be implemented using various display panel technologies, such as a liquid crystal display (LCD), an organic light emitting diode (OLED), a micro light-emitting diode (LED), and a quantum dot LED (QLED).

According to one embodiment, the display 111 may include a driving circuit for converting video signals provided from the processor 110 into pixel-level driving signals. Accordingly, screen characteristics, such as a resolution, a color, brightness, and a contrast ratio, may be adjusted. The display 111 may dynamically adjust the screen size, aspect ratio, and layout under the control of the processor 110. For example, depending on the type of content, the display 111 may be displayed in full screen or split screen format.

The display 111 may display not only simple video output, but also user interface elements, such as menus, icons, classification tabs, and notification windows. Accordingly, users may intuitively perform functions, such as content selection, storing, deleting, and sharing.

The display 111 may display not only video but also audio-linked subtitles, a playback control bar, and state information, and if necessary, may be combined with a touch input device to support user interaction.

According to one embodiment, the display 111 may mirror the same content or separately display some content in conjunction with the external electronic device 199.

According to one embodiment, the communication device 130 may be a module responsible for transmitting and receiving data between the video display device 100, the external server 190, and the external electronic device 199. The communication device 130 may include both wired and wireless network interfaces and support various communication standards.

According to one embodiment, the communication device 130 may include or be linked with the following components. The communication device 130 may include a local area network (LAN) port, HDMI-CEC (consumer electronics control), a DisplayPort, and USB wired communication ports. The video display device 100 may be directly connected or indirectly connected to the external server 190 or the external electronic device 199 via a home network. The communication device 130 may support wireless communication methods, such as Wi-Fi, Bluetooth, ZigBee, NFC, LTE, and/or 5G.

The video display device 100 may access the Internet or may be connected to an external electronic device 199 at a short or long distance in a wireless manner. The communication device 130 may manage network connection state under the control of the processor 110 and establish, maintain, and terminate a data session with the external server 190. The communication device 130 may perform retransmission or error recovery procedure in the event of a transmission error.

According to one embodiment, the communication device 130 may transmit and receive data, such as content, a scheduled transmission time, content location information, and user account information, with the external server 190. Power state information or user selection information of the video display device 100 may be transmitted to the external server 190. The communication device 130 may perform encryption, authentication, and access control functions during data transmission. Accordingly, it is possible to prevent unauthorized duplication or modification of content. The communication device 130 may transmit power state information, user selection information, or a retransmission request to the external server 190.

According to one embodiment, the memory 150 may be a storage device that supports the operation of the video display device 100 and stores and manages content. The memory 150 may include both volatile and non-volatile memories and may be implemented as a single chip or multiple modules, as needed.

In one embodiment, the memory 150 may store the content received from the external server 190. The stored data may be played or displayed through the display 111 when selected by the user.

The memory 150 may store visualized representative information (e.g., a preview image, thumbnail data) to identify the content, even when the entire content data has not been downloaded. The memory 150 may store metadata including the scheduled transmission time, content location information, user account information, and a device identifier received from the external server 190. This information may be used by the processor 110 to control a content display time point.

The memory 150 may manage the content storage period and, under the control of the processor 110, provide a notification before the expiration date or extend the storage period at the user's request.

The memory 150 may store a reference path for rereceiving expired content and location information provided from the external electronic device 199, thereby enabling the processor 110 to redownload the corresponding data if necessary. The memory 150 may store not only content but also the operating system, application programs, user settings, and log data of the video display device 100, thereby enabling the device to operate stably. The memory 150 may be used as a temporary storage space for data that may be referenced when storing content for a long time or redownloading the content.

According to one embodiment, the external server 190 may serve as a device for relaying and managing data between the video display device 100 and the external electronic device 199. The external server 190 may be implemented in various forms, such as a cloud server, a social network service (SNS) platform server, and a media content provision server. The external server 190 may store content, such as photos, videos, documents, and links uploaded by a plurality of users and transmit the content to the video display device 100 and/or the external electronic device 199 upon request. In addition, the external server 190 may manage the content transmission time according to user request or schedule settings, and provide the video display device 100 with metadata including the scheduled transmission time, content location information, a user identifier, and a device identifier.

The external server 190 may schedule content to be transmitted at a time when the video display device 100 is turned on, based on power state information transmitted from the video display device 100 or transmit the content immediately at a scheduled time. When the external server 190 transmits content immediately at the scheduled time, the video display device 100, which is currently turned off, may be turned on when the content reception begins or turned on in advance according to the scheduled transmission time received from the external server 190.

The external server 190 may manage the state of content shared in the chat space of the SNS platform and provide the content to the video display device 100. Furthermore, for the content whose storage period has expired, the external server 190 may provide the content location information in conjunction with the external electronic device 199 and support the video display device 100 to rereceive the corresponding content.

According to one embodiment, the external electronic device 199 is a mobile terminal, tablet, or laptop computer directly manipulated by the user and may be linked to the external server 190 to generate, upload, or request content.

The external electronic device 199 may be indirectly connected to the video display device 100 through an SNS application or a messenger application and may generate or select content, such as photos, videos, documents, and links, and upload the content to the external server 190.

The external electronic device 199 may be set to transmit content at a specific time or for a specific account, and when the user selects an account, may request the video display device 100 to display or transmit content linked to the corresponding account. When the storage period for content has expired, the external electronic device 199 may transmit file location information or a redownload request to the external server 190, and the video display device 100 may reference this information to rereceive content. In addition, the external electronic device 199 may perform two-way data exchange that may receive shared content from the video display device 100 or upload new content.

The video display device 100 according to various embodiments of the present specification may perform content display control based on the power state and the transmission time point in conjunction with the external server 190 and the external electronic device 199.

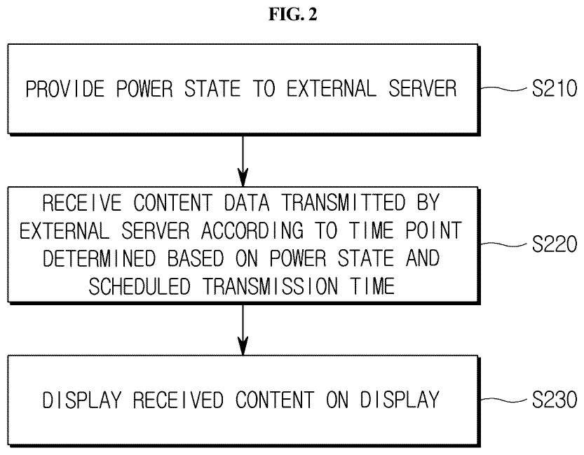

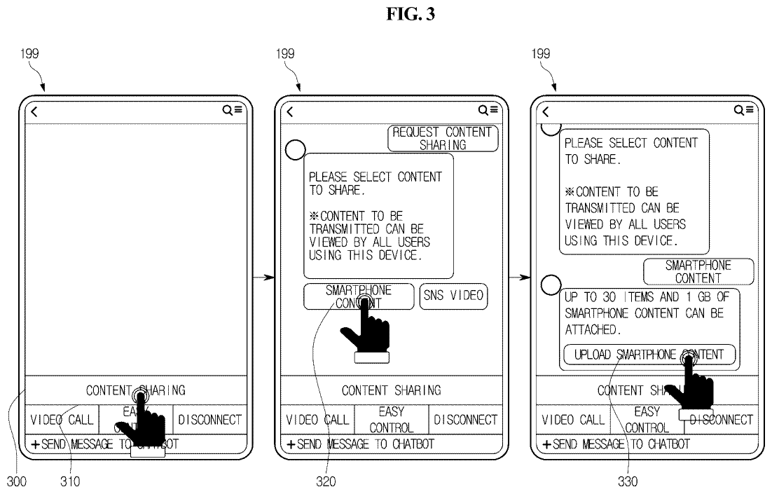

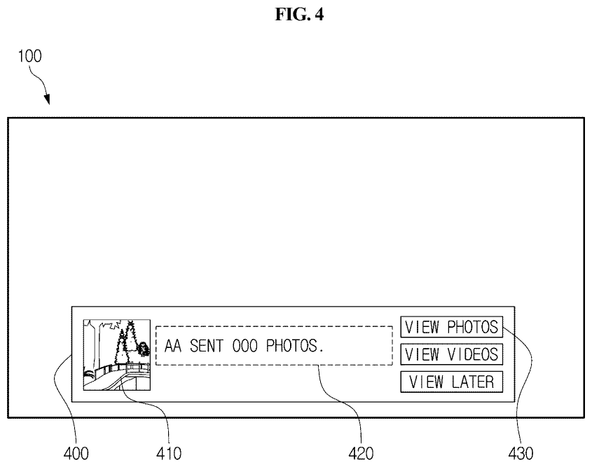

FIG. 2 is a flowchart illustrating a method of displaying content on a video display device according to one embodiment, FIG. 3 is an exemplary view illustrating a user interface for transmitting content from an external electronic device to the video display device, and FIG. 4 is an exemplary view illustrating a screen for providing a user with information on content received from an external electronic device on a display screen of the video display device according to one embodiment.

Referring to FIGS. 2 to 4, a method of displaying content of the video display device 100 according to one embodiment of the present specification may include an operation S210 of providing, by a video display device, a power state to an external server, an operation S220 of receiving the content transmitted by the external server 190 at a time point determined based on the power state and a scheduled transmission time, and an operation S230 of displaying the received content on a display.

In operation S210, the video display device 100 may transmit the power state to the external server 190. The power state transmitted by the video display device 100 may be an off state and an on state, but may additionally include a completely off state.

The off state is a state in which the display 111 of the video display device 100 is turned off, and a viewer of the video display device 100 may determine that the video display device 100 is turned off. However, in the off state, some modules of the communication device 130 and the processor 110 of the video display device 100 may operate in a low-power standby mode to perform minimal data exchange with the external server 190. In the off state, the video display device 100 may periodically transmit the power state of the video display device 100 to the external server 190.

The on state may be a state in which the display 111 of the video display device 100 is turned on and the communication device 130 and the processor 110 are also operating normally. In the on state, the viewer of the video display device 100 may be watching specific content.

The video display device 100 may be completely turned off when power is not fully supplied. In the completely turned off state, the processor 110 and the communication device 130 of the video display device 100 may not operate. When the video display device 100 is completely turned off, the external server 190 may not receive the power state of the video display device 100 for a predetermined time or longer. Then, the external server 190 may determine that the video display device 100 is completely turned off. When rereceiving the power state from the video display device 100, the external server 190 may identify the power state of the video display device 100 based on the received information.

According to one embodiment, in operation S210, the communication device 130 may set a network connection with the external server 190 and, under the control of the processor 110, transmit the power state of the video display device 100 to the external server 190.

Regardless of the operation of FIG. 2, the external electronic device 199 may request content transmission by allowing the user to select content to be shared through an application screen, as illustrated in FIG. 3, at any time and registering the type of the selected content (e.g., photos, videos, documents, and links), transmission policy (immediate transmission, scheduled transmission, and transmission upon power-on), and/or user account information with the external server 190. The external electronic device 199 may upload the entire original content or register content location information and visualized representative information instead of the original content in the external server 190, and the external server 190 may prepare data to be transmitted to the video display device 100 based on the registered information.

In operation S220, the video display device 100 may receive the content transmitted by the external server 190. According to one embodiment, the external server 190 may transmit the content to the video display device 100 at a time point determined based on the power state of the video display device 100 and the scheduled transmission time of the content.

The communication device 130 of the video display device 100 may receive the content in a streaming or download manner while verifying the integrity of the data through a secure channel, and in some embodiments, only the visualized representative information may be received before the entire data arrives. In addition, the communication device 130 may perform error detection, retransmission request, and decryption procedures during data transmission, and the received data may be temporarily stored in the memory 150.

The external server 190 may determine the transmission time point of the content by referencing the received power state information. For example, when it is determined that the video display device 100 is in an off state, content transmission may be scheduled at a scheduled time or when the video display device 100 turns on according to the content transmission policy set for the corresponding content.

When the video display device 100 is in an off state at the scheduled time, the video display device 100 may turn on by itself when content reception begins or may be turned on in advance according to the scheduled transmission time received from the external server 190. In operation S220, the processor 110 may determine the power state of the video display device 100, and when it is determined that the video display device 100 is in an off state, the processor 110 may turn on the video display device 100 when content reception begins.

According to one embodiment, when the video display device 100 receives and stores scheduled transmission information for content from the external server 190, the video display device 100 may be turned on at a scheduled content reception time point based on transmission scheduling.

According to one embodiment, in operation S230, the processor 110 may display the received content on the display 111. As illustrated in FIG. 4, the received content may have various forms, such as photos, videos, documents, and/or links, and user identification information uploading the corresponding content may be displayed together with the content. When multiple contents are provided, the processor 110 may categorize the content by type or subject and display the content on the display 111 in the form of tabs, lists, or thumbnails. In one embodiment, the corresponding information may be data received by the video display device 100 upon request from the external server 190. When a viewer selects a specific content among the multiple contents displayed on the display 111, the corresponding content may be downloaded to the memory 150 and played back in its entirety. For non-selected content, only visualized representative information may be maintained, and, if necessary, control may be performed to rereceive the original data from the external server 190 or the external electronic device 199. In addition, the display 111 may display user interface elements, such as a playback button, a watch-later button, and/or a delete button, allowing the user to intuitively explore, play back, and manage the shared content.

The following operations may be added after operation S220 or operation S230. The processor 110 may periodically receive the state of the content of the shared space managed by the external server 190 and display the state of the content on the display 111. In this case, the shared space may be a chat room, group chat room, or content sharing-only area on an SNS platform, and the type of shared content, sharer identification information, and/or upload time may be displayed together. The user may check the sharing history and select specific content to view or download.

The external server 190 may manage the state of shared content in the chat room or group chat space of the mobile terminal (external electronic device 199) in conjunction with the SNS platform. For example, when the user shares a photo or video in a mobile messenger chat room, the content may be recorded on the external server 190, and the video display device 100 may periodically synchronize the content and display the content on the display 111. During this process, the sender of the content, upload time, and chat room identification information may be provided, allowing the user to intuitively view the sharing history in the mobile chat room through the video display device 100. Furthermore, the processor 110 may perform functions such as filtering by chat room, sorting by user, and highlighting recently shared content, allowing the user to easily explore the content shared in the SNS chat room. By synchronizing and managing the sharing state in the messenger chat space, the user can easily view the content shared on the mobile device on a TV screen.

When the user selects a specific account on the video display device 100, the processor 110 may transmit content to the external electronic device 199 linked to the corresponding account. During this process, the communication device 130 may transmit a content transmission request through the external server 190, and the external server 190 may check target account information and route the content to the external electronic device 199. The external electronic device 199 may display the received content through a user interface and, if necessary, store or reshare the content.

The method of displaying content according to the embodiment may include automatically controlling content display based on a power state and a transmission time point to allow the user to smoothly view content without performing any power operation.

Referring to FIG. 3, the external electronic device 199 may allow the user to select content to share through the messenger screen. For example, the user may select a content sharing button within a menu window 300 including a plurality of buttons 310 displayed on the display of the external electronic device 199. Then, a content sharing request screen may be displayed on the screen. The content sharing request screen may include shared content selection buttons 320. The shared content selection buttons 320 may include a smartphone content button and an SNS video button. When the user selects the smartphone content button, the external electronic device 199 may sequentially select content to share and upload the selected content by pressing the upload button 330. When the user selects the SNS video button, the external electronic device 199 may provide content location information and representative information of the corresponding video to the external server 190.

Referring to FIG. 4, the video display device 100 may provide content received from the external server 190 to the user in a pop-up form via the display 111. Previously displayed content or videos may continuously be displayed over the entire display 111, and a pop-up screen 400 indicating the receipt of new content may be displayed over the existing video. The pop-up screen 400 may display visualized representative information 410 (e.g., a thumbnail), the sender, and related information 420 of the content, and options, such as viewing photos, viewing images, and/or viewing later, may be provided via a user interface 430. When the user selects a specific option within a predetermined time, the corresponding content is downloaded from the server 190, stored in the memory 150, and played back over the entire display 111. When the user does not select a specific option within the predetermined time, the video display device 100 may store the content-related information 410 and 420 in the memory 150 and remove the corresponding pop-up screen 400.

According to one embodiment, the processor 110 may generate or receive visualized representative information to provide the user with identifiable information without downloading all the received content. The visualized representative information 410 may be implemented as, for example, a thumbnail image for photo data, a preview frame or still image of a representative scene for video, a cover image or summary page for documents, or a favicon or preview capture screen for link information. Such visualized representative information may be stored in the memory 150 as low-capacity data and provided such that even non-selected content may be intuitively checked by the user on a list screen. By downloading and playing back the entire data only for the selected content, storage resources can be efficiently used and network loads can be reduced.

The video display device 100 according to the embodiment may intuitively display user information together with the received content and manage the entire content or representative information according to the user's selection.

Through the embodiments according to FIGS. 2 to 4, by organically linking content transmission via the external electronic device 199, transmission management by the external server 190, and content display via the video display device 100, the user can easily share and explore various content.

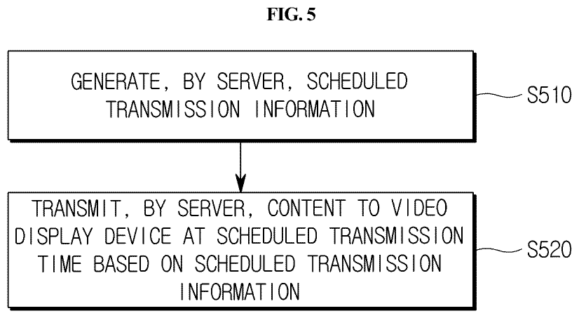

FIG. 5 is a flowchart illustrating a process of transmitting scheduled content from an external server according to one embodiment.

Referring to FIG. 5, a method of managing scheduled content transmission information may include an operation S510 of generating, by the server 190, scheduled content transmission information, and an operation S520 of receiving, storing, and managing, by the video display device 100, the scheduled transmission information.

In operation S510, the server 190 may receive a content transmission request provided from the external electronic device 199 and generate scheduled content transmission information based on the request. The external electronic device 199 may provide the server 190 with content or content location information together with a user-specified transmission policy (immediate transmission, scheduled transmission, transmission upon power-on).

Based on such information, the server 190 may generate metadata including scheduled transmission time, content location information (e.g., file path, URL), user account information, and/or a device identifier and set the metadata as scheduled content transmission information. The external server 190 may include the size, type (photos, videos, or documents), and/or visualized representative information (thumbnail or preview data) of the content in the scheduled content transmission information.

In operation S520, the external server 190 may store and manage the generated scheduled transmission information. In addition, the external server 190 may transmit the corresponding content to the video display device 100 at the scheduled transmission time based on the stored scheduled content transmission information.

Additionally, the external server 190 may transmit the scheduled content transmission information to the video display device 100. According to one embodiment, since the external server 190 may store and manage the scheduled content transmission information for a plurality of video display devices 100 and a plurality of external electronic devices 199, the external server 190 may extract only scheduled content transmission information for the corresponding video display device 100 and transmit the extracted scheduled content transmission information to the corresponding video display device 100.

The communication device 130 of the video display device 100 may receive the scheduled content transmission information from the server 190. The processor 110 may store and manage the received scheduled content transmission information in the memory 150 and control a content reception time point based on this information. For example, when the scheduled transmission time is set to a specific time and the video display device 100 is in an off state when the corresponding time arrives, the processor 110 may turn on the video display device 100, receive content from the external server 190, and display the content on the display 111.

According to one embodiment, when the received scheduled content transmission information includes a device identifier, the processor 110 may determine whether the corresponding device identifier is the same as the device identifier of the controlled video display device and store and manage the corresponding scheduled content transmission information only when the device identifiers are the same. The processor 110 may simultaneously manage a plurality of scheduled transmission information and determine priorities by user and/or content type to control the display order.

The external server 190 and/or the video display device 100 according to the embodiment may manage content transmission and display based on the scheduled transmission information, thereby automatically displaying content at the scheduled time without user intervention.

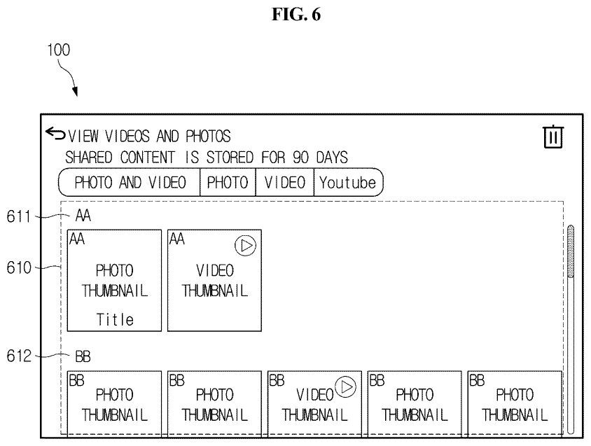

FIG. 6 is an exemplary view illustrating a screen for displaying content received from a plurality of users on the video display device according to one embodiment.

Referring to FIG. 6, the display 111 of the video display device 100 may display content shared by a plurality of users separately according to each user account. A first account 611 corresponds to user AA, and a list 610 of photo and video content transmitted by the corresponding user is included and displayed. A second account 612 corresponds to user BB, and a plurality of photo and video content items transmitted by the corresponding user are displayed separately under an account group.

The processor 110 may receive multiple contents transmitted by the plurality of users from the external server 190, analyze user identification information or account information provided together with each content, and control the display to display the content according to each user. Classification tabs (photos, videos, and/or links) by content type may be displayed at the top of the screen, and content groups by user account may be hierarchically listed in a screen area.

According to one embodiment, the separation of content groups by user account, as illustrated in FIG. 6, is performed by the external server 190, and the video display device 100 may request the corresponding information from the external server 190, receive the corresponding information from the external server 190, and displays the received information on the display 111.

The user may select a specific account on the screen of FIG. 6 displayed on the display to view only the content for the corresponding account or view the content for all accounts in a consolidated list.

The processor 110 may assign identifiers, icons, or name labels to content for each user account to enable the intuitive distinction of the user and provide different sorting methods based on the transmission time, size, and/or type of the content. In some embodiments, the user may download content or extend its storage period for each account and receive separate notifications for content shared by specific accounts.

The video display device 100 according to the embodiment can efficiently manage content even in an environment shared by multiple users by displaying the content separately according to each user account.

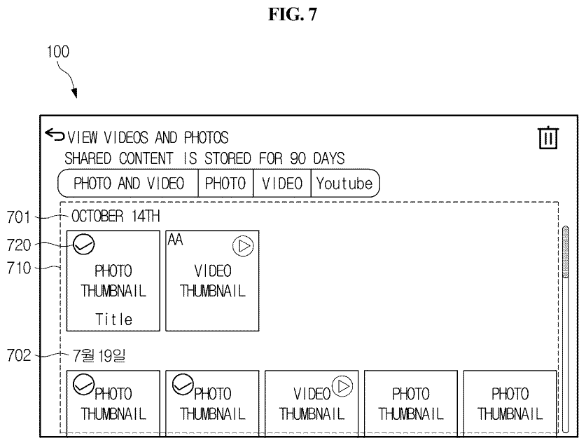

FIG. 7 is an exemplary view illustrating a screen for displaying content classification and classification menu display operations according to one embodiment.

Referring to FIG. 7, the display 111 of the video display device 100 may display the received content items classified by type and date. At the top of the screen, classification tabs for each content type (“Photo and Video,” “Photo,” “Video,” and/or “YouTube”) are displayed, allowing the user to select a desired classification. For example, when the user selects the “Photo” tab, only photo data may be displayed, and when the user selects the “Video” tab, only video data may be filtered and displayed.

Content received on a specific date 701 (e.g., October 14th) may be grouped as visualized representative information, such as photo thumbnails and video thumbnails and displayed on the screen. Content received on another date 702 (e.g., July 19th) may be displayed in separate groups, enabling the user to intuitively explore content by date or type.

The processor 110 may automatically classify content received via the communication device 130 by type (photos, videos, documents, and/or links) or content (e.g., specific keywords, topics) and provide a corresponding classification menu via the display 111. When no specific type of content is present, the corresponding classification tab may not be displayed on the screen or may be provided in an inactive state.

In some embodiments, the user may select multiple contents simultaneously from the classification screen, and the selected content may be distinguished by visual objects such as check marks 720. Content selected by the user may be downloaded and stored in the memory 150, and only visualized representative information may be maintained for non-selected content. Accordingly, storage resources can be efficiently used, and at the same time, the user can selectively store and play back only the content intuitively desired.

The video display device 100 according to the embodiment may display content classified by type and date, allowing the user to quickly and intuitively explore desired content.

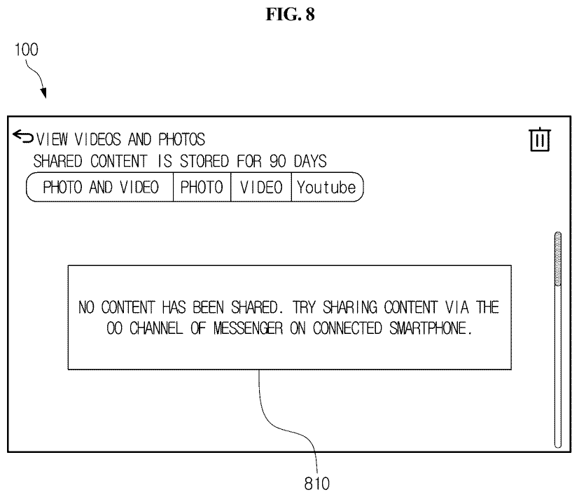

FIG. 8 is an exemplary view illustrating a screen when there is no shared content according to one embodiment.

Referring to FIG. 8, the display 111 of the video display device 100 may display the content classified by specific type on the display 111. At the top of the screen, content classification tabs (“Photo and Video,” “Photo,” “Video,” or “YouTube”) are provided, allowing the user to select a desired classification item.

For example, FIG. 8 illustrates a screen in which a specific classification tab is selected, but no content corresponding to the selected type is present. In this case, the display displays a message 810 stating “There is no shared content,” and guidance text may also be provided to allow the user to share content via another device.

The processor 110 may automatically classify the content received via the communication device 130 by type, and when no specific type of content is present, a guidance message may be controlled to be displayed in an area corresponding to the corresponding classification tab. The guidance message may encourage the user to share content via a connected smartphone or external electronic device 199, which may facilitate intuitive user understanding and contribute to activating the content sharing function.

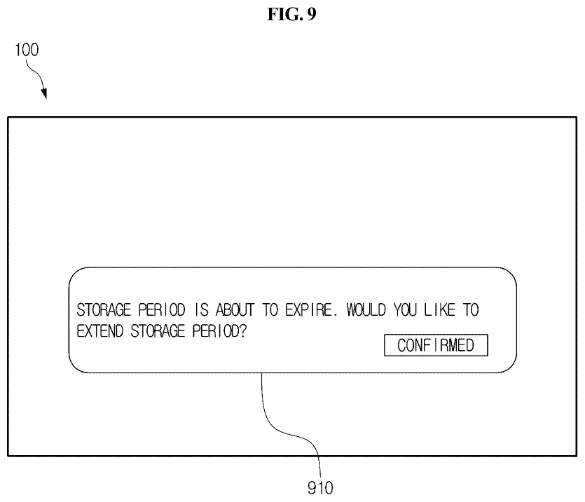

FIG. 9 is an exemplary view illustrating storage period management and expiration notification according to one embodiment.

Referring to FIG. 9, a notification message 910 may be provided to the user on the display of the video display device 100 before the storage period expires. The notification message 910 may be displayed, for example, in a form of “The storage period is about to expire. Would you like to extend the storage period?” and the user may select a confirmation button to extend the storage period.

The processor 110 may periodically check the storage period of the content stored in the memory 150 and provide a notification to the user via the display 111 before the expiration date. When the user requests an extension, the processor 110 may additionally set the storage period for the corresponding content to ensure that the content is maintained without being deleted. Conversely, when the user does not select an extension, content that has reached the expiration date may be automatically deleted, or only visualized representative information may be maintained.

In one embodiment, the extension of the storage period may be processed in conjunction with the external server 190. For example, when the video display device 100 transmits an extension request signal to the external server 190, the server 190 may update the storage policy for the corresponding content and ensure that the corresponding content remains accessible through the video display device 100.

According to one embodiment, the video display device 100 may allow the user to efficiently use the storage space and reliably store necessary content through storage period management and expiration notification functions.

According to one embodiment, the processor 110 may manage the storage period of the content stored in the memory 150 or the external server 190 and provide a notification to the user before the expiration date. The notification may be provided in various forms, such as a pop-up window on the screen of the display 111, a notification icon in a status bar, a voice guidance message, and/or a push notification to the external electronic device 199. When the user selects the confirmation button or the extension button included in the notification, the processor 110 may control the storage period to be updated so that the content is maintained without being deleted. Conversely, when the user does not extend the storage period, the content may be automatically deleted upon expiration, or only visualized representative information may be maintained. In some embodiments, the extension request may be synchronized with the external server 190, ensuring that the storage policy is also updated in a server storage. Accordingly, data between the user terminal, the server, and the video display device 100 can be consistently managed.

The video display device 100 according to the embodiment may provide a notification to the user before the storage period of the content expires and extend the storage period according to the user's selection.

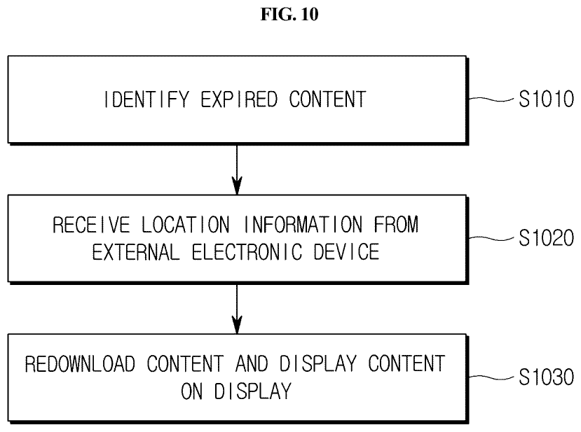

FIG. 10 is a flowchart illustrating a process of rereceiving content by referencing location information of an external electronic device according to one embodiment.

Referring to FIG. 10, a procedure for reobtaining and displaying content whose storage period has expired may include an operation S1010 of identifying expired content, an operation S1020 of receiving location information from the external electronic device 199, and an operation S1030 of redownloading the content by referencing the location information and displaying the content on the display 111.

In operation S1010, the processor 110 may periodically check the storage period of the content stored in the memory 150 or the external server 190 to identify expired content. The expired content may be managed in a list, and whether rereceiving is possible may be displayed through a user interface in a state in which only visualized representative information is maintained. In some embodiments, the processor 110 may initiate a rereception procedure when accepting the rereception request of the user after providing the notification illustrated in FIG. 9.

In operation S1020, the communication device 130 may receive location information on the content from the external electronic device 199. The location information may include an identifier of a storage in which the original content is stored, an access path, resource identification information, and/or access authorization information and may be transmitted through direct communication with the external electronic device 199 or communication via the external server 190. In this case, the processor 110 may verify the validity and access authorization of the location information, and, if necessary, perform procedures, such as updating an authentication token, reestablishing a session, and/or exchanging encryption parameters. When the location information is updated or an alternative path is provided, the processor 110 may manage the information to prioritize the most recent information.

In operation S1030, the processor 110 may control the communication device 130 to rereceive the content by referencing the received location information. Rereception may be performed in a streaming or file downloading manner, and depending on network conditions, segment-by-segment retransmission, interruption recovery, and error recovery procedures may be performed. The rereceived content may be temporarily or permanently stored in the memory 150 and immediately displayed on the display 111 or controlled to be played back upon user selection. Before all data is ready, visualized representative information may be displayed first, and the screen may be updated depending on the reception progress. When access authority is restricted or a network error occurs, the processor 110 may set a retry schedule or provide a guidance message to the user.

According to the above procedure, the video display device 100 may use location information provided from the external electronic device 199 even for the content whose storage period has expired to rereceive and display content from the corresponding location. This effectively uses a storage space and allows the user to reaccess past content when needed.

According to one embodiment, the processor 110 may receive location information of the corresponding content from the external electronic device 199 or the external server 190 to reobtain the content whose storage period has expired. The location information may include, for example, a file path or storage directory information, a cloud resource identifier, an access URL, authentication token, and a path and permission information of a network drive. The processor 110 may verify the validity of the received location information and control the communication device 130 to redownload or stream the content from the designated location. In this case, depending on network conditions, segment-by-segment transmission, interruption point resumption, and error recovery procedures may be performed. Before all data is received, visualized representative information may be displayed first, and the screen may then be updated depending on the reception progress. Through this process, the user may reaccess expired content by referencing the original storage location information, thereby providing long-term data management and user convenience at the same time.

The video display device 100 according to the embodiment may rereceive expired content by referencing location information provided from the external electronic device 199.

In the video display device, system, and control method thereof according to the embodiment, content may be independently received and displayed in conjunction with the external server, thereby enabling smooth content sharing while minimizing user intervention. In particular, since content display may be automatically controlled according to the power state and the transmission time point, the user can immediately view content without having to turn on the device or set a schedule.

By transmitting power state information to the server and managing the scheduled transmission time, location information, and/or identification information, content can be appropriately displayed at the scheduled time. Content from a plurality of users may be classified by user and classified and displayed by type or content, and when no specific type of content is present, the corresponding classification menu may be automatically controlled.

Stable data management is possible by providing notification and storage extension functions prior to expiration of the storage period, and the content whose storage period has expired may also be rereceived by referencing the location information of the external electronic device. In addition, by managing the shared space state of the external servers, up-to-date shared information can be provided to the user, and by downloading only content selected by the user and maintaining only representative information for non-selected content, storage resources can be efficiently used.

When the user selects a specific account, content may be transmitted to the external electronic device linked to the corresponding account, enabling two-way sharing and expanded utilization of the content. Accordingly, the invention according to the embodiments can simultaneously achieve both the convenience of content sharing and management efficiency.

The present specification has been described with reference to various embodiments illustrated in the drawings, but these are merely illustrative, and those skilled in the art will understand that various modifications and other equivalent embodiments are possible therefrom. Accordingly, the true technical scope of the present specification should be determined by the technical spirit of the appended claims.

What is claimed is:

1. A video display device comprising:
a communication device configured to transmit and receive data with an external server;
a display configured to display content; and
a processor configured to control the display to display the content,
wherein the processor is configured to:
provide a power state of the video display device to the external server; and
receive the content from the external server and display the content on the display at a time point determined based on the power state of the video display device and a scheduled transmission time of the content.

2. The video display device of claim 1, wherein the processor is configured to:
display information on the content received from the external server on a pop-up screen of the display; and
display the content on the display when a display option is selected by a user.

3. The video display device of claim 1, wherein the processor is configured to turn on a screen of the display and change the power state of the video display device to an on state when beginning to receive the content from the external server while the power state of the video display device is in an off state with the display turned off.

4. The video display device of claim 1, wherein the processor is configured to receive scheduled content transmission information including a scheduled content transmission time, content location information, and one or more identification information from the external server.

5. The video display device of claim 4, wherein the processor is configured to turn on a screen of the display and change the power state of the video display device to an on state before the scheduled content transmission time when the power state of the video display device is in an off state with the display turned off, and to wait for content reception from the server.

6. The video display device of claim 1, wherein the processor is configured to group a plurality of received contents according to identification information of a user transmitting the corresponding content and display the grouped content on the display.

7. The video display device of claim 1, wherein the processor is configured to classify a plurality of received contents according to content type or theme, and to group and display the classified content according to content type or theme.

8. The video display device of claim 1, wherein the processor is configured to periodically determine whether a storage period of content stored in the video display device or the external server has expired, and to provide a notification before the storage period expires.

9. The video display device of claim 1, wherein the processor is configured to upload content within the video display device to the server so as to be transmitted to an external electronic device linked to a specific account when a user selects the specific account.

10. A method of displaying content of a video display device, which displays content requested by an external electronic device on a display in conjunction with an external server, the method comprising:
providing a power state of the video display device to the external server;
receiving the content from the external server at a time point determined based on the power state of the video display device and a scheduled transmission time of the content; and
displaying the received content on the display.

11. The method of claim 10, wherein the displaying of the received content on the display comprises:
displaying information on the content received from the external server on a pop-up screen of the display; and
displaying the content on the display when a display option is selected by a user.

12. The method of claim 10, wherein the displaying of the received content on the display includes:
turning on the display and changing the power state of the video display device to an on state when beginning to receive the content from the external server while the power state of the video display device is in an off state with the display turned off; and
displaying the received content on the turned-on display.

13. The method of claim 10, further comprising receiving scheduled content transmission information including a scheduled content transmission time, content location information, and one or more identification information from the external server.

14. The method of claim 13, further comprising turning on a screen of the display and changing the power state of the video display device to an on state before the scheduled content transmission time when the power state of the video display device is in an off state with the display turned off, and waiting for content reception from the server.

15. The method of claim 10, further comprising grouping a plurality of received contents according to identification information of a user transmitting the corresponding content and displaying the grouped content on the display.

16. The method of claim 10, further comprising:
classifying a plurality of received contents according to content type or theme; and
grouping and displaying the classified content according to content type or theme.

17. The method of claim 10, further comprising:
periodically determining whether a storage period of content stored in the video display device or the external server has expired; and
displaying a notification message on the display before the storage period expires.

18. The method of claim 10, further comprising uploading content within the video display device to the server so as to be transmitted to an external electronic device linked to a specific account when a user selects the specific account.

19. A method of operating a content sharing server, comprising:
receiving a content transmission request in which a scheduled transmission time point to a video display device is set from an external electronic device;
receiving a power state from the video display device;
determining whether to transmit the content to the video display device based on a power state of the video display device and the scheduled transmission time point; and
transmitting the content to the video display device based on the determination.

20. The method of claim 19,
wherein the determining of whether to transmit the content to the video display device includes:
determining transmission of the content at the scheduled time point regardless of the power state of the video display device; or
determining transmission of the content when the power state of the video display device is in an on state with the display turned on after the scheduled time point.
